(19) United States
(12) Patent Application Publication
(10) Pub. No.: US 2017/0178228 A1
(43) Pub. Date: Jun. 22, 2017

(54) COMPUTER-IMPLEMENTED SYSTEM AND METHOD FOR LISTING AND EXCHANGING GOODS AND SERVICES

(71) Applicants: Giovanni GALIANO, Toronto (CA); Paul GABRIELE, Toronto (CA); Richard WACHSBERG, Toronto (CA)

(72) Inventors: Giovanni GALIANO, Toronto (CA); Paul GABRIELE, Toronto (CA); Richard WACHSBERG, Toronto (CA)

(21) Appl. No.: 15/338,342

(22) Filed: Oct. 29, 2016

Related U.S. Application Data
(63) Continuation of application No. PCT/CA2015/050370, filed on Apr. 30, 2015.
(60) Provisional application No. 61/986,394, filed on Apr. 30, 2014.

(51) Int. Cl. G06Q 30/08; G06F 17/30; G06Q 30/06; G06Q 30/02

(52) U.S. Cl. CPC G06Q 30/08; G06Q 30/0277; G06F 17/30312; G06Q 30/0643

(57) ABSTRACT

Systems and methods are disclosed to provide a computer platform enabling the listing of articles for sale, trade, barter or advertisement. New listings may be compared to previous listings and if similarities above a threshold are found, a bidding process is triggered for a priority display of the listing on a website. The bidding process may enable a listing to be displayed in a priority position or manner to a user requesting the article or a similar article. The systems and methods also support bidding among users for the acquisition of the article and deducting and credit real and virtual currency accounts associated with users and bidding processes.

CROSS-REFERENCE TO RELATED PATENT APPLICATIONS

The application claims the benefit of U.S. Provisional Application No. 61/986,394, filed on Apr. 30, 2014 and is a continuation of PCT Application No. PCT/CA2015/050370, filed on Apr. 30, 2015. The complete disclosure of each of U.S. Provisional Application No. 61/986,394, and PCT Application No. PCT/CA2015/050370 is incorporated herein by reference.

### FIELD OF THE INVENTION

The present application relates to a method and system performed over a communications network for exchanging goods and services. The present application further relates to a computer system for comparing listings of goods and services, identifying similar listings, and enabling users to bid for priority display of similar listings.

### BACKGROUND OF THE INVENTION

The protocol which operates over the worldwide computer network known as the worldwide web or Internet has opened up many new ways to disseminate goods and services and interact with a network of individuals and businesses that share common interests desP1te being widely separated by geography and other barriers. For example, services such as eBay™ and Amazon.com™ allow suppliers of goods or services to reach a worldwide market with a relatively low investment of resources on the part of the vendors. At the same time, such services allow interested businesses and individuals to reach a highly targeted audience such as persons who are searching for a product or service with relatively narrow market appeal. As a result, the Internet and other networks provide highly efficient mechanisms for marketing and purchasing goods and services. In addition, social networks such as Facebook™ and Twitter™ have greatly expanded the ability of individuals, businesses and other entities to establish personal networks and to interact between networks, thereby allowing for a highly efficient transfer of information within self-selected communities and networks.

The raP1d expansion of the Internet has opened up new opportunities for individuals and businesses to exchange a wide variety of goods and services. It is known to purchase articles over the Internet through such popular websites as Ebay, Priceline™ and other auction-based websites. TyP1cally, such websites offer services similar to a live auction, in which articles are sold to the highest bidder (or other auction models such as reverse auctions), using money as the medium of exchange. Such systems are widely accepted, but they can promote behaviours that are limited to one of either buying or selling activities on the part of participants. As such, these systems are not always ideally suited to a social network environment wherein it can be desirable to promote a sharing of goods and services, wherein participants are actively encouraged to both supply and receive goods and services.

The present inventors have previously developed a system and method for the creation, management and sharing of “sample bags” between members of a network. According to this previous invention, a user may create a sample bag comprising an assemblage of virtual samples that may consist of digital images, text or other information that corresponds to selected articles. Users of this network may display, promote and share such sample bags, thereby exchanging information regarding a wide range of goods and services in a simple, organized fashion. In some cases, users of this system may wish to acquire the physical goods that are represented by the virtual samples.

### SUMMARY OF THE INVENTION

The present system is intended to encourage users to offer goods or services for trade within the system, or to list requests for goods or services, to thereby promote exchanging goods and/or services between users. In some embodiments, exchange units are primarily generated by vending goods or services to other users, and such exchange units can be spent only within the system, a self -perpetuating system of circulating and exchanging articles is promoted. This objective, and others, can be promoted with the use of a non-financial medium of exchange that promotes a sharing or exchange-type network.

According to one aspect, the invention relates to a computer system for fixed price bidding for an article over a computer network from a vendor to a plurality of bidders wherein an article is offered by the vendor for a fixed number of non-financial exchange units and said bidders bid for said article by sequentially increasing the financial price they commit to pay to a third party for the right to acquire the article from the vendor for said fixed number of exchange units. The system comprises a host computer comprising a memory and a processor, said processor comprising computer program instructions to:

maintain a database populated with data relating to a plurality of said articles including descriptive or representational information and a defined numbers of exchange units tradeable for each of said articles, said database comprising a virtual market (“VM”) of tradeable articles;

for any one of said articles, define a set of bidders having at least said defined number of exchange units within their individual accounts for acquiring said article;

enable bidding by said bidders whereby a monetary payment is automatically transferred from each of said bidders to a third party in response to a bid, said payment incrementing upwardly with each successive bid; and

upon the close of bidding, transferring the specified number of exchange units from the winning bidder to the first user.

The system may further comprise a means to form a pre-established connection between a user and a third party for automatic financial transfers to the third party for bidding for said articles.

The system may further comprise a means to generate said exchange units in response to actions by a user selected from supplying an article to another user through an auction, establishing a new account, and making a payment to the third party.

The system may further comprise a means to increment the bid amounts upwardly by a selected amount after each successive bid. The selected amount may be determined from the number of exchange units selected for said article.

The system may further comprise a means for automatically transferring said payment from each of said bidders at the close of bidding, said payment comprising for each bidder the sum total of said monetary payments for said bids submitted by that bidder.

The system may further comprise a means to populate said VM with articles comprising the steps of:

providing at the host computer a template accessible over the network to said users for comP1ling a virtual listing comprising an assemblage of virtual products or services comprising computer-readable data, said template comprising a user interface transmitted over the network to a first of said users;

receiving at said host computer over said computer network a listing from the first of said users and a designation of the status said listing as being private for viewing and sharing only by designated others of said users or public for sharing by designated others of said users and viewing by any person over said network, and configuring a computer database of the host computer to store said listing and designated status in a user-searchable format;

receiving at said host a request to share said listing from a second of said users;

responsive to said request, identifying from data stored in said host whether said second user is a designated user and transmitting said listing for viewing and sharing by a designated one of the second users to the node of said second user, and then updating the host database to designate said listing as being shared between said first and second users

receiving from a designated one of said second users a request to perform one or more of copying at least one of said virtual products or services into a listing of said second user, posting a comment in said shared listing or adding a new virtual product or service into the shared listing; and

updating the host data base to modify the listing as requested by the second user and store said modified listing.

According to another aspect, the invention relates to a method for fixed price bidding for an article over a computer network from a vendor to a plurality of bidders wherein an article is offered by the vendor for a fixed number of non-financial exchange units and said bidders bid for said article by sequentially increasing the financial price they commit to pay to a third party for the right to acquire the article from the vendor for said fixed number of exchange units. According to this aspect, the method comprises the steps of:

establishing a database populated with data relating to a plurality of said articles including descriptive or representational information and a defined numbers of exchange units tradeable for each of said articles, said database comprising a virtual market (“VM”) of tradeable articles;

for any one of said articles, defining a set of bidders having at least said defined number of exchange units within their individual accounts for acquiring said article;

enabling bidding by said bidders whereby a monetary payment is automatically transferred from each of said bidders to a third party in response to a bid, said payment incrementing upwardly with each successive bid; and

upon the close of bidding, transferring the specified number of exchange units from the winning bidder to the first user.

According to a further aspect, the method comprises the further step of establishing in said database for a given article whether the article is available for either one of auction or barter. This option may be established at the time the database for the article is populated or alternatively subsequent to this time. If the vendor selects the “auction” option for the article, then the method proceeds according to the steps recited above. If the vendor selects the “barter” option for the article, then a user who identifies the article may communicate a private message to the vendor. A return private message may be sent from the vendor to the user. The private messages are communicated electronically through a host computer. The contents of the private messages are determined solely by the respective senders, such that the given article may be exchanged for barter or other value.

Optionally, the barter parties may be credited with exchange units in their respective accounts based on the shipP1ng costs respectively paid for the bartered items. According to this option, the barter parties communicate with the host computer, which then automatically credits their respective accounts based on the shipP1ng cost information included in said communication.

Optionally, one or both of the barter parties may be charged a fee upon listing of an article for barter and/or upon completion of a barter exchange.

According to a further aspect, all users including vendors, bidding parties and barter parties may participate in a rating system whereby any user may rate the performance of any other user who has participated in an auction or barter exchange with the user. According to this aspect, at the conclusion of an auction or barter exchange, the host transmits a communication to all users, wherein the names of other users are identified therein. For example, if a given user is a vendor, he can be provided with the usernames of other bidders, which may comprise all other bidders or only the winning bidder. If the given user is a bidder, the communication may identify the vendor. The identified parties in the communication may be ranked, for example on scale of 1-5. The rankings may comprise overall rankings and/or categorized rankings appropriate to the class of ranked user. For example, if a vendor or barter exchange party is being ranked, the rankings may relate to categories such as promptness of shipP1ng, accuracy of description/photos, and other relevant ranking categories.

Rankings of purchasers may relate to promptness of payment and other relevant factors.

According to a further aspect, there is provided a computer system for listing and display articles over a communications network. The computer system comprises a memory, a communications interface configured to send and receive data over a communications network; and a processor configured to: generate a website to support the advertisement and exchange of articles; receive a command to generate a new listing for an article associated with a user, the listing comprising keywords and information relating to the article; determine that the new listing is similar to one or more previously generated listings stored in the memory; and trigger a first bidding process for a first display priority for the new listing and one or more similar previously generated listings.

In another aspect, there is provide a method comprising, generating a website to support the advertisement and exchange of articles; receiving a command to generate a new listing for an article associated with a user, the listing comprising keywords and information relating to the article; determining that the new listing is similar to one or more previously generated listings stored in the memory; and triggering a first bidding process for a first display priority for the new listing and one or more similar previously generated listings.

### DEFINITIONS

The following terms shall have the meanings described below in this patent specification:

“Article” means any product or service that may be physically shipped or provided from one person to or for the benefit of another person or is capable of being owned by a person and transferred to another person and which can at least potentially be the subject of a commercial transaction. An article also may comprise a combination of a service and a physical product.

“Computer” refers to a computing device including mobile, wired or wireless devices, capable of performing basic computing functions including in most cases data storage, processing, memory access and connection to the Internet. It will be understood that with raP1d advances in computer technology, the term “computer” is likewise evolving-it is not intended to limit this term to any particular computing technology except as described herein.

“Vendor” refers to a person, who may be a natural person or other legal entity, who lists or makes available an article for trading in the present system in exchange for credits/exchange units.

“User” refers to a user connected through a user computer via the

Internet to a host computer, for interacting with the present system. A user may be any entity, whether that entity is registered as a member or otherwise.

“Member” refers to a user who has registered information with the host computer and is recorded in the host database as a member.

### BRIEF DESCRIPTION OF THE DRAWINGS

FIG. 1 is a block diagram of a communications system according to one embodiment of the present system.

FIGS. 2 to 6 represent block diagrams showing examples of methods of operation of the present system.

FIGS. 7A to 7C are sample displays showing operation of the present system.

### DETAILED DESCRIPTION

The present system 10 is operable over a communications network 12 such as but not limited to the Internet. The present system 10 is operated and controlled by a host computer 20 which maintains an on-line connection to the communications network 12. Host computer 20 comprises a memory 22 and a processor 24. Multiple databases, described below, are stored in the memory 22 and can be updated and modified by the processor 24. In some embodiments, the host computer 20 comprises a server and it will be appreciated that the functions of the host computer 20 and databases may be implemented by multiple servers or processing and storage devices. The host computer 20 can maintain a secure on-line connection to a financial institution computer or network 30 for processing of payments by users and other financial transactions. The communications between host computer 20 and financial institution 30 may be Internet-based or alternatively may comprise a secure non-Internet connection or a non-Internet computer connection for improved security. Host computer 20 is programmable with any suitable computer language or means to perform the operations described herein.

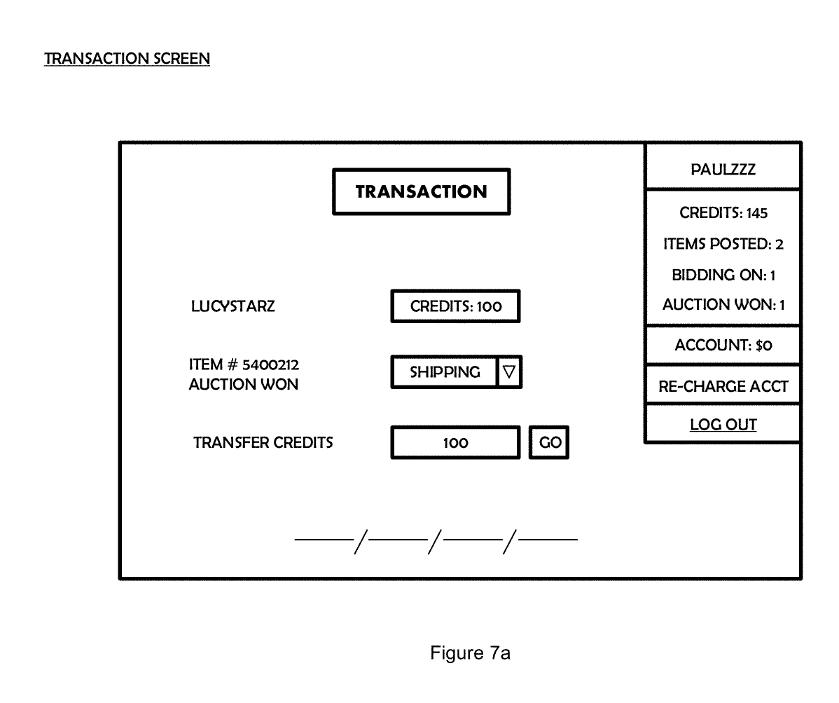

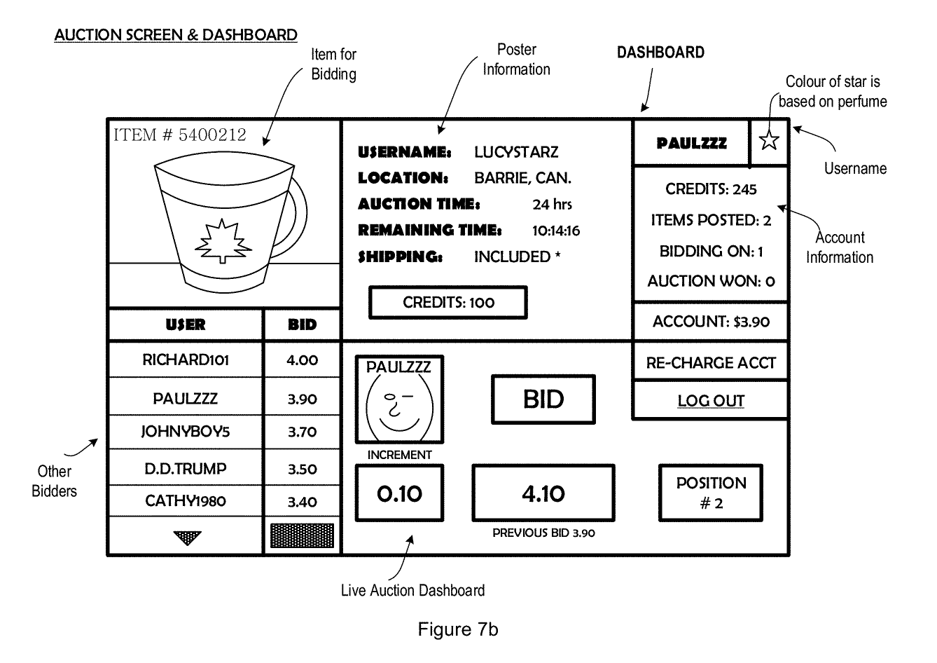

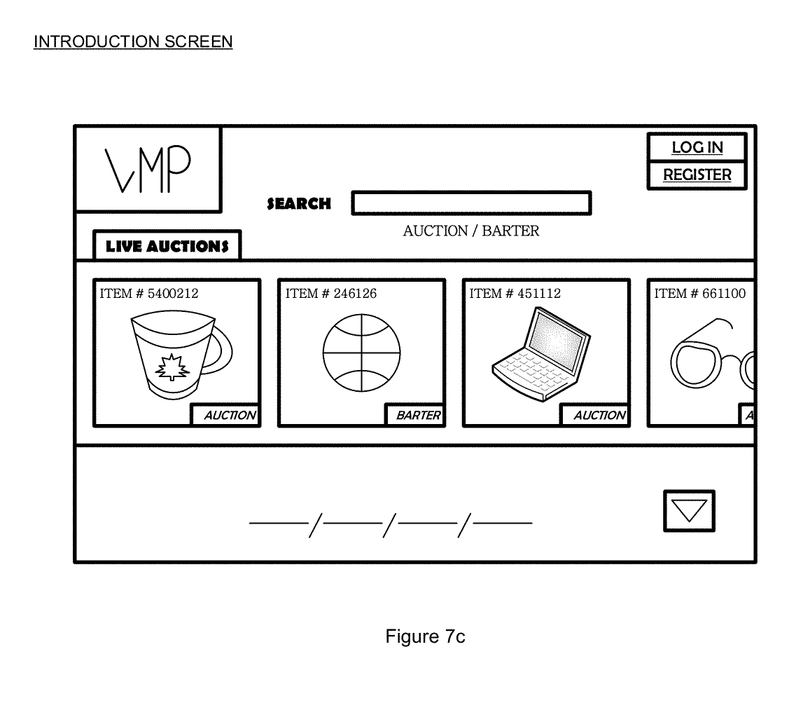

The host computer 20 may host a Virtual Market website 50, as shown in FIGS. 7A and 7B and described further below, for web-based interactivity with multiple users. The host computer 20 including the memory 22 and processor 24 may be configured to perform “cloud” computing functions for users whereby operational control and data storage of user computers is centralized within host computer 20 and may be accessed over the Internet by users on a temporary, on-demand basis which may be web-based.

In one embodiment, the present system permits users to trade articles with a combination of currency and non-financial credits. A “credit” consists of a non-financial marker or exchange unit that can be generated by a system user who has been registered to perform certain activities over the system. A credit is generated by performing specified activities within the present system. A credit may be transferred within the system to another user in exchange for an article. A credit consists of a virtual (non-physical) unit of exchange that can be exchanged within the present system, normally with other users in exchange for articles. Outside the system 10, a credit has no official value and cannot normally be exchanged. A credit may be assigned or correlate to an arbitrary value such as one U.S. dollar, a specified fraction of a Bitcoin™ or other arbitrary external value. This facilitates calculations of certain financial exchanges within the system 10 which correlate monetary payments with credit-based transactions, as described below. Alternatively, the value of a credit may be free-floating whereby it has no arbitrary value tied to any outside unit of exchange.

Credits are referred to herein as “Virtual Market credits” or “VM credits” to clearly distinguish such credits as non-financial exchange units that differ from financial instruments.

VM credits may be earned by users through any one of several specified activities. For example, host computer 20 may credit each new member a selected number of VM credits upon registration of the new member. VM credits may also be generated by auctioning or listing an article within the present system. For this to occur, a user must offer an article for trade within the present system. For this purpose, the user establishes auction conditions, including selecting a specified number of VM credits that are required in order to acquire the article. If the article is successfully auctioned within the system, the specified number of VM credits is then transferred from the account of the acquirer to the vendor's account. VM credits may also accumulate within an acquirer's account upon acquiring of an article from another member. For example, if the acquirer compensates the vendor financially for shipP1ng costs, the acquirer may then be reimbursed for this expense in the form of VM credits which are credited to the acquirer from the host, based on a predetermined valuation such as one VM credit for each U.S. dollar (or equivalent) spent by the acquirer for shipP1ng costs. Additionally, acquirers may be credited with VM credits when they pay a financial amount to system 10, for example when placing a bid. Optionally, members may transfer VM credits as between themselves, for any purpose. Optionally, VM credits may be generated for other activities such as listing articles for auction or other selected activities performed within the system 10.

Computer memory 22 stores an updateable database populated with product information which may include product information provided by users. This database is populated with information about articles that are at least potentially available for bidding by users. Collectively, this data comprises a “virtual market” (VM), which is a database accessible by user computers. The VM consists of comP1led data supplied by specified users of the system 10 relating to specific articles which users wish to make available for trading to other users. It is contemplated that such traded articles will primarily consist of relatively small physical products that can be physically transferred with conventional delivery services. However, articles traded in the system need not be limited in these respects. The VM is accessible to any user, who may search within the VM database for viewing articles and, if registered with the system 10, to list and/or bid on articles.

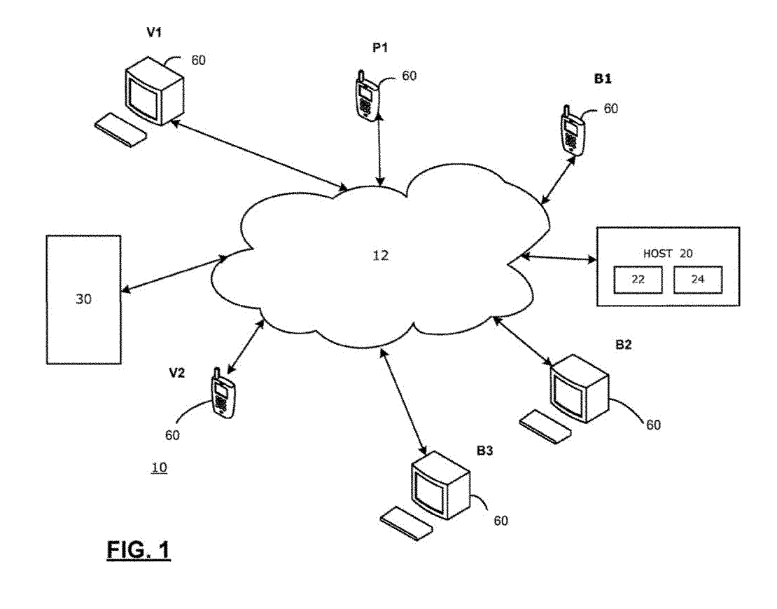

The VM is accessible through the host website 50 to multiple classes of users through a user computer 60 as illustrated in FIG. 1. The user computer 60 may comprise any wired, wireless, mobile or other communications or electronics device configured to support a user interface and communications over the communications network 12. The user computers 60 illustrated in FIG. 1 also are labelled to refer to different role(s) which may be associated with the user of the device 60. Users designated as V₁ and V₂ act as vendors of different articles. A second user P₁ represents a public, non-registered user. Users B₁, B₂ and B₃ represent registered users who are prospective acquirers of articles from V₁. These users may bid against each other for the right to acquire an article for a specified number of VM credits. A given user may for some purposes be a vendor and for other purposes be an acquirer. In other embodiments, users such as vendors V₁, V₂ may bid for a display position for the listing of a vendor's article on the VM website 50.

The memory 22 in the host computer 20 further comprises a user database, populated with data specific to individual users of system 10. This information includes account information, payment information, bidding history and VM credits available to the user.

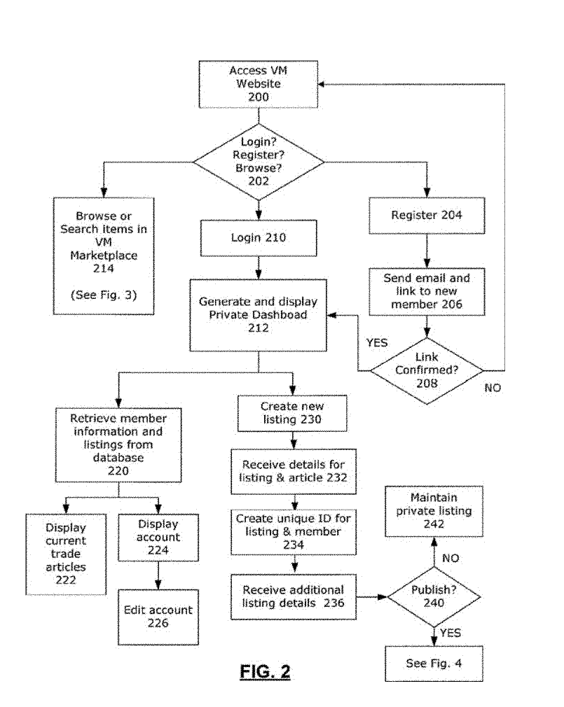

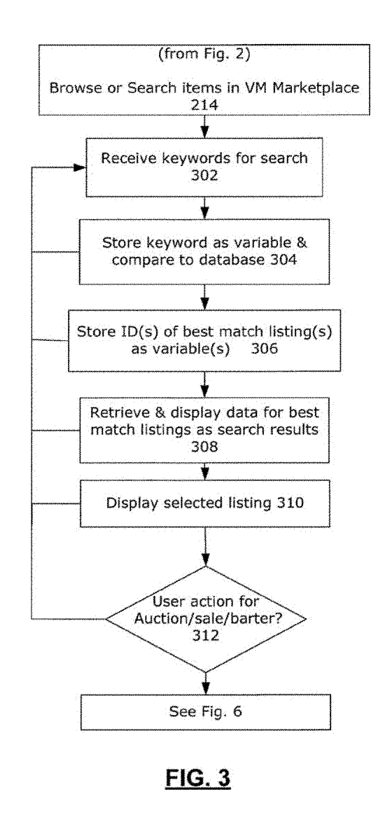

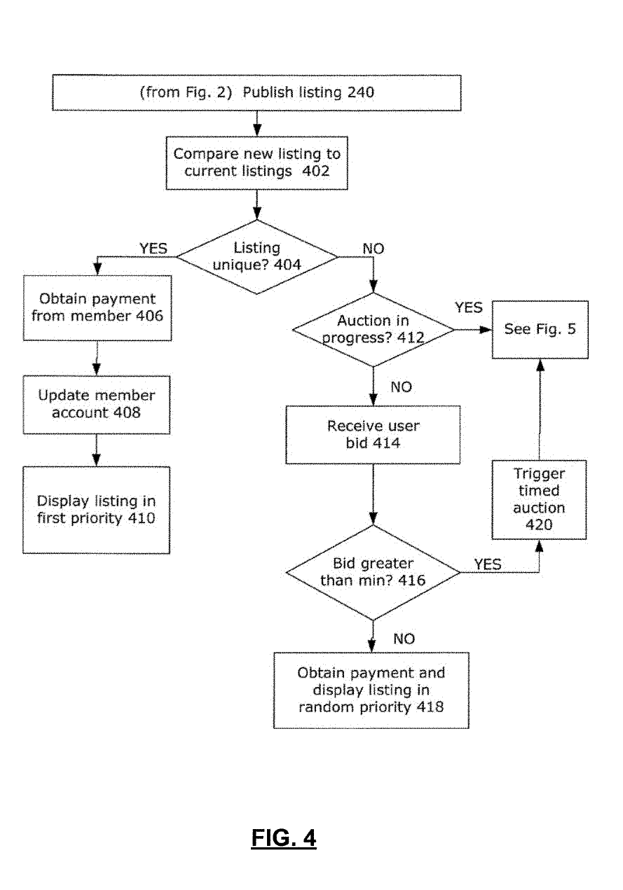

The operations of the present system will now be described from the perspective of a public user P₁ with reference to FIGS. 2-6. When public user P₁ initially accesses 200 the VM website 50, a temporary database is established within memory 22. User P₁ is then prompted 202 to select one of three initial options, and the received selection is transmitted to the host computer 20.

As a first option, (i) user P₁ can register (action 204) as a registered user of system 10. In this stage, legal documents such as terms of service and other legal/policy information are transmitted to P₁'s computer and P₁ is asked to agree to these policies and agreements. After user P₁ enters consent to such terms, the user's consent is then transmitted to the host computer 20. The host computer 20 generates a confirmation link and sends this link in an email 206 to the new user P₁, inviting user P₁ to respond. User P₁ then responds by selecting the confirmation link from the email. The confirmation link is checked (action 208) against a temporary link that was previously generated and saved in the temporary database generated when the new user initially accessed the website. If the two links match, it can thus be determined and confirmed that the new user's email is correct which completes the registration process. If confirmation links do not match and the user P₁'s email is not confirmed, the user is re-directed to the VM home page 200 to restart the registration process. Once the user P₁'s email is confirmed, then user P₁ becomes a private user (either a vendor V₁V₁ or one of bidders B₁₋₃, depending on whether the user wishes to acquire, browse or vend an article) and a private dashboard for the new user is generated (action 212).

In a second option (ii), if the visitor to the VM website is an existing member, whether a vendor V₁V₁ or a bidder B₁-B₃, that visitor may login (action 210) using a user name, password and other previously established information. In one embodiment, not shown, following the login step, the member is presented with an election to either proceed to the private dashboard or to return to the main VM website 50.

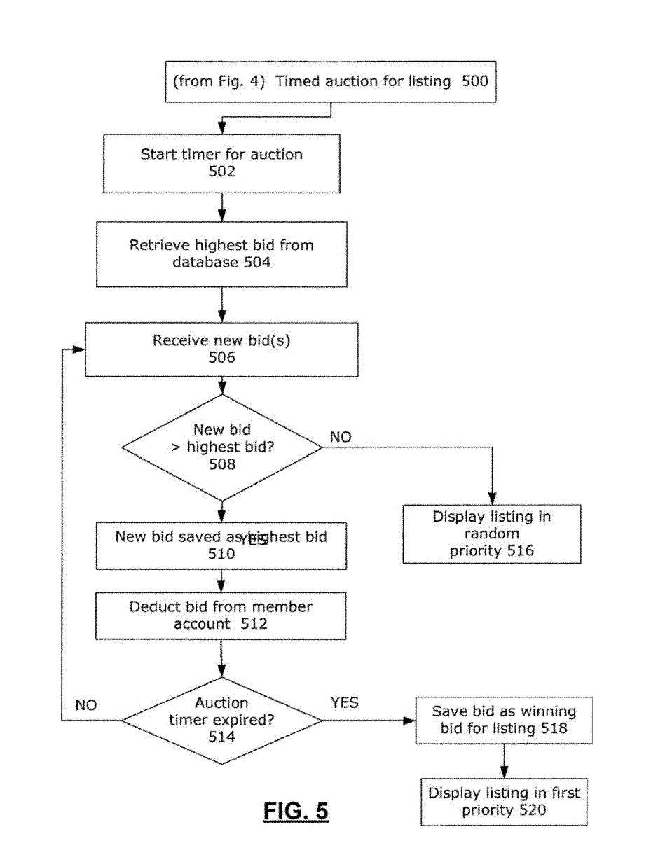

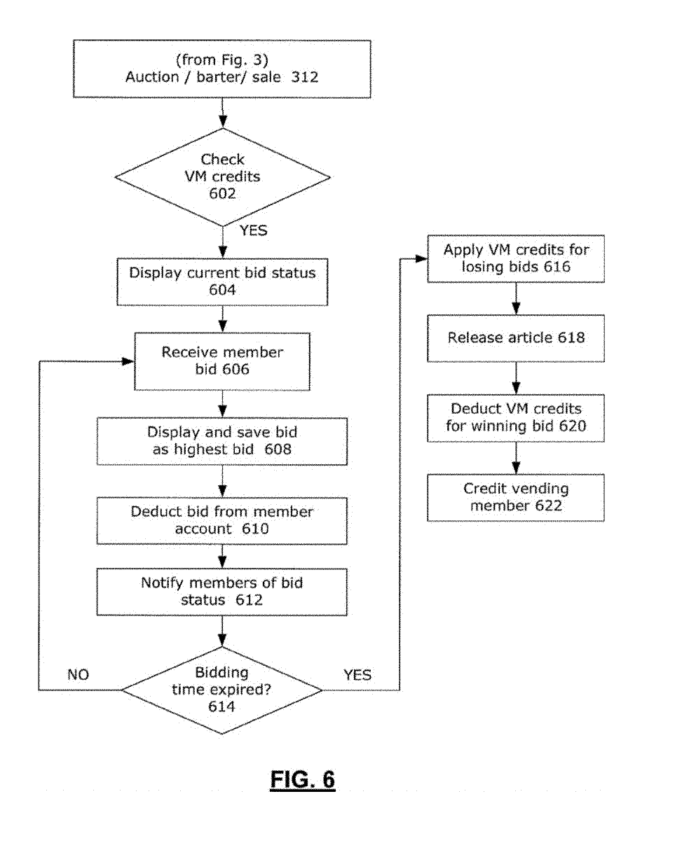

In a third option (iii), if the public user P₁ elects to neither register nor login the user P₁ may elect at step 84 to either browse or perform a more targeted search 214 for items available in VM website 50. The browse or search function may be initiated by the host computer 20 following a prompt transmitted from the host computer 20 to the user's computer. Alternatively, the browse or search function may be initiated following accessing by the user's computer of VM website 50, at steps 30 and 32. Particulars of the browse/search sequences are described below with reference to FIG. 3.

Once a user has been registered, the user may access a private dashboard, which is generated and transmitted from host computer 20 for display on the user's computer. The private dashboard displays details of articles that have been listed for trade on the VM website 50 by that member. Relevant details concerning such articles may include article titles, descriptions, images and other identifying information as well as the number of VM credits that are required to trade for the item.

From the private dashboard, the user, now logged in to the system 10 as member V₁ or B₁₋₃ may be presented by the host computer 20 with two options.

In the first option, the host computer 20 retrieves from the database in memory 22 information about the member's account, listings created by the user, bids entered by the user, or a combination of this information. Information about listings for current articles available for trading may be retrieved and transmitted to the member for display 222 on the member's computer 60. The information may include details about the member's listings of articles to be traded such as current bid amounts, the member's trading history, previously traded articles of similar types, and image, video or audio files describing or relating to the article in the listing. This information may include details about on-going or closed auctions in which the member has previously placed a bid. The retrieved and displayed information can include the bid history for a given article and its present bid status. The trading history can be presented in various formats such as tables, charts, graphs, etc. The associated articles can be represented with any combination of text, graphics, video and other display forms. In one embodiment, the host computer 20 is configured to search or detect in the database in memory 22 listings for articles available from or requested by other members which may be similar to the articles or listings generated by the user. The host computer 20 may be configured to compare a list of similar articles identifying key words in common between the articles presented in the first option, as well as pre-determined synonyms thereof.

The information retrieved and displayed for a member may include account information 224 such as current number of VM credits available to the member for bidding on articles, the member's purchase history and currently linked payment methods. Certain member information may be presented to a member for verification and editing (action 226) such as contact information, credit card information and the like.

In one embodiment, the member must link a payment method for real currency transactions to the member's VM account. By editing account information (action 226), the member may provide information for a credit card, PayPal™ account or the like. The member's payment information is encrypted and stored in a database and may be retrieved, viewed and edited by a user. The payment method is linked to the member's VM account and in one embodiment, such linkage is required in order for the member to place bids for articles within the system. The payment also may be verified through an existing online verification system or partner company to ensure validity. If the payment method cannot be verified, the member is sent a warning email and prompted re-enter information, enter information for a new payment method or logout. If the payment method is verified, the system 10 credits the new member with a specified number of credits. The specified number of VM credits may be predetermined for each member or can be based on other criteria, and this provides the member with VM credits to start trading articles. The newly generated VM credits are then saved to the database as an entry specific to this member. In one embodiment, rather than linking a payment method to the member's VM account, a deposit of a selected amount of real currency may be paid to the system 10 through any of the payment methods described above. The real currency credit is also saved to the database as an entry specific to the member and may be deducted as real currency is spent by the member.

A second option that the member may select from private dashboard is to create a new listing 230 for an article in the system 10. The type of listing as an article for sale, auction, barter or advertisement is also received by the host computer 20 from a member's selection. The host computer 10 prompts the user through the user's computer for details regarding the article and type of listing to be created. These details can be entered into a predetermined form which is presented to the member V₁ and contains different fields depending on the type of listing selected. To list an article for sale, the user V₁ may be prompted to enter information such as an article description, item price and currency, shipping cost and shipping location. To list an article for auction, the user V₁ may be prompted to enter information such as an article description, virtual credit value and shipping value. To list an article for barter, the user V₁ may be prompted to enter information such as an article description and a description of the article the user V₁ would like to receive in exchange. In one embodiment, an article for barter includes an identification of an article, that is a good or service, needed or requested by the user, such as a request for transportation from an airport to a second location for a particular city, time and day, and an article, VM credit or real currency amount the member would offer in exchange. To list an article for advertisement, the user V₁ may be prompted to enter information such as a title, article description, keywords, and target audience, which may be characterized by age group, gender, and location. The information received for a listing is saved in the host database in association with a unique identifier (ID) which is generated 234 for the member and the specific article of the listing. In one embodiment, following the creation of the unique ID, the member is prompted to enter additional information for the created listing which is received 236 by the host computer 20, such as a title, description, keywords, and target audience, which may be characterized by age group, gender, and location.

Once sufficient information is received for a listing, the member is prompted to publish the listing 240. If the listing is not published, information associated with the listing and its unique ID remains private in the database in the memory 22 of the host computer 20 for further editing and review by the member. The private listing is only viewable by the member who created the listing and the private listing is not made part of an auction for display priority as described below. If the member requests the listing be published and made available and visible to other members of the system 10, further actions are taken by the host computer 20 as shown in FIG. 4.

As illustrated in FIG. 3, a user or member may, upon accessing the VM website 50 select options to browse or search 214 for one or more articles listed for advertisement, sale, auction or trade in the system 10. The user or member is prompted to provide keywords and other information relating to the type of search, such as but not limited to ranges or limits on the price or VM credits required for the item, ranges or limits on current bids, and time limits for the bids captured by the search. In one embodiment, the bid amount is determined as the percentage of the VM credit amount. Once the host computer 20 receives the keywords for a search 302, it stores each keyword in the memory 22 as a keyword variable and compares 304 each keyword to every word and phrase stored in the database. Keywords provided by the user are compared against all words, phrases, keywords, locations and other criteria stored in the database pertaining to information about all products, member profiles, location information etc. Results are determined and retrieved by the host computer 20 based on a percentage match of all relevant information. The unique ID(s) associated with listings having the greatest percentage of matching keywords are stored as second variable in the memory 22 of the host computer 20. The information stored in association with each best match listing(s) is then retrieved and displayed 308 to the user.

In one embodiment, the display 308 of listings from the search results includes determining a first priority listing of the best match listings as described herein. The first priority listing may be a current highest bidder for the best display position amongst members who have generated similar listings. The first priority listing maybe displayed to the user in a more prominent or favourable position in the display of search results. Other listings, or all listings where no first priority listing is present, may be displayed in a random or predetermined order or set of positions.

When displaying 308 the search results, the host computer 20 may provide the user or member with a number of different options for browsing, sorting and view the listings of the search results. The user or member may be provided with an option to rank the results, for example by most recently listed, time remaining for an auction, number of credits required to acquire the article and other criteria. The host computer 20 may accept new or modified keywords and search parameters from the user or member and return to action 302. The host computer 20 also may allow a user to sort and view listings by type, such as to view items for auction, items for barter or items for sale.

In response to receiving a user or member selection of a listing, the listing associated information regarding the article for that listing is displayed 310 by the host computer 20 to the user or member. The displayed information may include images, video, audio files and any other information entered by a member when the listing was created. The information may include other particulars or characteristics such as shipP1ng costs, vendor location and others, as well as the number of VM credits required to acquire the item, the bid amount expressed, for example, in U.S. dollars, the remaining bid time left in the auction as a countdown, the current number of bids, the current bid amount (i.e., the amount paid by the most recent bidder) and the cost required to beat the current bid, i.e., the cost to the user to submit a new bid for the selected item. If the listing type is an advertisement, the information displayed may include an option or link to redirect the user to a website affiliated with the advertisement in order to purchase the product.

Following the display of a specific selected listing, the host computer 20 may prompt the user or member to take an action 312 regarding the listing as described below with respect to FIG. 6. It will be appreciated that at any time during the search and display of listings, the user may return to enter or revise keywords for a search 302.

Prior to publishing a listing, the system 10 is configured to determine whether competing listings exist and to operate a bid process for such listings. As shown in FIG. 4, after a user selects to publish a new listing 240 which the system has created for the user, the host computer 20 compares (action 402) the new listing with all listings which have been previously generated and saved in the VM database. Listings are checked for similarity by the host computer 20 using key word and term matching algorithms to determine a best percentage match with the new listing. The host computer determines whether the new listing is unique (action 404). If the percentage match is greater than a predetermined threshold, such as 80%, the host computer 20 identifies that the new listing matches at least one existing listing in the VM database and is not unique. Otherwise, if the new listing is unique, the member is prompted to provide or confirm payment for the listing (action 406). The payment the member provides for the listing may be a predetermined minimum payment or a payment offered by the member. The payment received for the listing is recorded as the member's bid for the listing which is stored by the system 10 and compared against subsequent member listings. The member may confirm payment as a charge to the payment method linked to the members VM account or as a deduction of the member's prepaid deposit of real currency as described above. If the member's prepaid deposit contains insufficient funds for the listing, the member may be prompted to add a real currency payment. Where the charge for the listing is deducted from the member's real currency deposit, the member's VM account is updated (action 408) and the listing is displayed to other members (action 410). Since the new listing is unique, it is assigned a first or highest priority for displaying to members. The listing associated with the first priority may be displayed on the VM website 50 in the best or preferred location or manner for that type of listing, such as but not limited to a far right side or far left side or top of a website display. It will be appreciated that the best or preferred location or manner or timing of a displayed listing on the VM marketplace website 50 may vary depending on the content of the listing, the type of listing, the time of day, target users and many other factors. The new listing is associated with the first priority until the listing expires or is withdrawn, the article or subject of the listing is acquired or fulfilled, or another listing triggers an auction process for members to bid for the display position.

If the new listing is found not to be unique, i.e. the new listing is similar to one or more current listings, the member will be prompted to bid for display position and priority against the members associated with the matching listings. The host computer 20 next determines (action 412) whether a bidding process or auction is currently in progress involving one or more of the listings which met the matching criteria. No auction in progress indicates that an auction between similar listings has been completed. If no auction is in progress, the member who generated the new listing is prompted to enter a bid (action 414) in a real currency amount. Prior to entering a bid, the member may be provided with information regarding the bids or amounts of real currency paid by members owning similar listings and the winning bid amount from a previous auction. The bid received from the member is compared (action 416) against the bids provided by members for previously published listings or the winning bid from a previous auction for the best display position for the listing. Alternatively, the member may bid an amount greater than a number predetermined by the system, for example $1 US. If the bid received for the new listing is less than or equal to prior bids for similar listings (or predetermined system amount), payment is obtained from the member, as described above, and the listing is published and displayed to other members (action 418). The new listing may be displayed along with similar listings in random priority for the best display position.

If the bid received for a new listing is greater than bids provided by members for previously published listings or the winning bid from a previous auction, or predetermined system amount, a new auction process is triggered (action 420) and carried out in accordance with the method illustrated in FIG. 5.

Once an auction for the best listing position is triggered, the host computer 20 starts (action 502) an internal timer which controls the duration of the bid. The duration of the bid is typically determined or preconfigured by the system 10 and may be for example, 48 hours. The highest bid associated with the current first priority listing is retrieved (action 504) from the VM database 50 and displayed to members associated with listings which are part of the auction process. As described above, a listing of an article for trade, barter, sale or advertisement may be identified and associated with an auction based on a new unpublished listing matching one or more existing listings. The highest bid retrieved from the database may represent the highest bid from a previous auction process or a bid received for a new listing, such as at action 416 in FIG. 4. In one embodiment, the member associated with the current highest bid for a listing at the start of the auction receives a message or alert from the system 10 notifying the member that a new auction has started to vie for the display priority for the member's particular listing.

One or more bids may be received (action 506) by the host computer 20 from members associated with the listings which are associated with the auction. In one embodiment, bids may be incremented by predetermined amounts. For each received bid, the host computer 20 may first determine whether the real currency account associated with the member has funds sufficient to cover the payment for the bid. If the real currency account has insufficient funds, the member maybe prompted as described above, to confirm a payment method or submit a deposit of prepaid funds to the member's VM real currency account. If funds are sufficient and the bid can proceed, the received bid is compared (action 508) to the current highest bid.

If a new received bid is higher than the current highest bid, the new bid is saved 510 in the database as the highest bid and the bid amount is deducted (action 512) from the member's real currency account on each successful bid. In one embodiment, the listing associated with a received bid which is determined to be higher than the current highest bid is temporarily displayed as the first priority listing for the duration of the auction or until a higher bid is received for another listing. The host computer 20 determines (action 514) whether the auction has exP1red and if not, the system 10 waits to receive new bids (action 506).

If a received bid is not greater than the highest bid in an ongoing auction, the listing associated with the lower bid is displayed (action 516) on the VM market website with a random priority as described above. In one embodiment, if the member does not participate in a current auction related to the member's listing, that listing will continue to be displayed in a random priority provided that the member has previously submitted a bid or payment to publish the listing.

Once an auction exP1res, the current highest bid and the member and listing associated with the highest bid are saved (action 518) in the database as the first priority listing for that auction. The listing having the unique ID associated with the winning bid is assigned the first priority for display over similar listings and is displayed (action 520) in a best position on the VM market website or search results, as described above. In one embodiment, at the end of the auction, a member who had temporarily submitted a higher bid which was deducted from the member's real currency account at action 512 is provided with a VM credit to the member's VM credits account proportional or equivalent to the amounts bid by the member. The listing having the unique ID associated with the winning bid is assigned the first priority for display retains the first priority until the listing exP1res or is withdrawn, the article or subject of the listing is acquired or fulfilled, or another listing triggers an auction process for members to bid for the display position.

In one embodiment, where a member has created a listing for an article for barter, such as a request for a specific good or service, the host computer 20 is configured to compare the new barter listing with listings stored in the VM database. The comparison may be performed as described above using key word and term matching algorithms to determine a best percentage match between existing listings offering articles for sale, auction, barter or advertisements and the new barter listing. Existing listings which are determined by the host computer 20 to match the new barter listing may be displayed through the VM market website to the member associated with the barter listing. In one embodiment, the member may be notified by the system 10 that listings have been found and determined to match the barter request in the members listing or the member may receive a message such as an email message containing the matched listings. In this instance, a best percentage match may have a different threshold than described above for a search function and may, for example, display a predetermined number of the best matched listings to the member associated with the new barter listing.

In one embodiment, members associated with the listings which are determined to match the new barter listing receive a notification from the system 10. These members may initiate an auction process as described above to compete for the priority listing for display to the member of the barter listing. Alternatively, the system 10 may be configured to create an auction for this purpose and invite members with matching listings to participate in the auction. The members bid using real currency as described above which reflects the member's interest in having the member's listing presented as the topped ranked or priority bidder, which may provide that member with an improved chance to complete a successful transaction. The listing associated with the winning bid is displayed with the first or highest priority, such as being at the top of a list and the remaining listings may be displayed with random priority. In the example described above, where a member has created a barter listing requesting transportation from an airport to a second location for a particular city, time and day, once a comparison with current listings is performed by the system 10, and optionally once an auction is completed to vie for priority in the display of matched listings, the member who created the barter listing is notified. The member may visit the VM market website 50 and be presented with a display of potential service providers such as limousine or taxi services available to meet the request.

The methods described above provide processes for generating and publishing listings created by members to display articles for auction, barter or sale, or advertisements to other members of the VM marketplace website 50 and to public users. Members may participate in auctions as describe above to bid against members with similar listings to ensure the member's listing(s) receive first priority treatment and the best or preferred display position when displayed on the VM marketplace website 50. Such displays may occur on the VM marketplace website 50 as other members or users browse listings by category or conduct keyword searches for articles as described above.

FIG. 6 illustrates a method according to embodiments of the present application for members to bid for the articles associated with the listings displayed on the VM market website 50. Following a review of listings on the VM marketplace website 50 or a search by a user as described for FIG. 3 above, a user may select to participate in an auction, or to barter, or purchase an item if the user has registered and logged into the system 10. The user may select a listing which include articles for sale, view the details of the articles and select an option to purchase the article. For listings relating to the sale for real currency of an article, the VM member is directed to a webpage associated with the vendor of the listing to conduct the transaction outside the VM system 10. Alternatively, the user may select a listing which includes information about articles for barter, view the details of the articles and initiate a request to connect with the vendor to complete the barter transaction. The vendor associated with this listing is notified and may either decline the inquiry or agree to the member's request and trade the article. In the latter case, the member is provided with the contact information for the vendor. Alternatively, the system 10 may support the exchange of private messages between members regarding articles exchanged for barter. The contents of the private messages are determined solely by the respective senders, such that the given article may be exchanged for barter or other value. In one embodiment, the barter parties may be given or have deducted VM credits in their respective accounts based on the shipP1ng costs respectively paid for the bartered items.

According to this option, the barter parties communicate with the host computer, which then automatically credits their respective accounts based on the shipP1ng cost information included in said communication.

FIG. 6 shows further details of the actions completed by the system 10 where a member has selected an item which has been listed for an auction. The host computer 20 initially checks the member's account for VM credits to ensure the member has sufficient VM credits to bid on the article in the selected listing. If the VM credits are insufficient, the member is notified and prompted to purchase or obtain more VM credits, such as by posting and selling articles for trade or sale within the present system. If the VM credits are sufficient, a current bid status is determined and displayed 604 to the member. The bid status normally comprises the current number of bids for the item. In one embodiment, in order for the member to place a bid, the member must “catch up” to the bid status by bidding an equal amount plus one bid. For example, if 10 members have each bid once for a listing and the current number of bids is 10, the new member wishing to participate must submit a bid of 11 bids. In one embodiment, the bid amount is calculated as a percentage of the number of credits the article is listed for. For example, if the article is listed for 10 credits, a set bid amount maybe 1% or $0.01 in real currency and to gain the highest bidder position requires 11 bids or $0.11. In one embodiment, the bid amount is automatically set at the incremental amount that represents the predetermined increase from the previous high bid.

Once a bid is received (action 606) from a member, the host computer 20 performs a check, as described above for FIG. 4, to determine whether the member's real currency account has sufficient funds to support the bid. If funds are sufficient, the bid is posted to the website 50 and stored in the VM database. The bid information is stored in conjunction with the bidding members ID, as well as selected bid information such as the date and time of the bid, the total bid amount and other selected information. The VM database also may store the current number of bids for the item. At this point, the new bid has been entered and the bidder is committed to pay the bid amount regardless of whether that member wins the auction. In one embodiment, if the member leaves the bidding page, logs out or shuts down their computer, the real currency value of the member's bid will be deducted from the member's VM real currency account when the bidding time exP1res.

If a new bid is greater than the current highest bid for the article in the listing, the new bid is displayed and saved 608 in the VM database as the current highest bid. In one embodiment, all information comP1led both during and after the bidding process, including the member ID of all winning and non-winning bidders the dates and times of bids, the total bid amount and other selected bid information is saved in the VM database. Information about the member associated with the current highest bid, such as a username, also may be displayed. A value corresponding to the current highest bid amount is deducted 610 from the member's real currency account on each bid. Alternatively, bids from members may be tracked and values according to the bids entered may be deducted from the member's real currency account after the bidding ends. When a new winning bid occurs, bidding members may be notified 612 of their status in the bid. In one embodiment, the member with the winning bid is notified of a first place status and all other members receive information only of a non-winning status. If the bidding time, as set by the system 10 or by the vendor who created the listing, has not exP1red, further bids may be received for the article.

Once the bidding time has exP1red 614, the winning bid information is saved in the VM database and may be displayed again along with the username of the member who won. The host computer 20 determines VM credits 616 for all members who submitted losing bids and these credits are applied to each members VM account. For example, a VM credit may be tied to the U.S. dollar, wherein a member who has paid $1.0 for their bidding activity is then credited with one VM credit, which the member may then use in a future auction for a different article. Finally, the article of the listing is released for trade 618. The VM credits corresponding to the winning bid are deducted 620 from the winning member's VM credit account. A corresponding number of VM credits is added to the vending member's VM credit account. Both member's VM credit accounts are updated in the VM database.

The respective member with the winning bid and the vendor are supplied with each others personal contact information and the respective parties may then contact each other to arrange for shipP1ng and reimbursement of shipP1ng costs. In one embodiment a shipping cost may be calculated by host computer 20. This calculation may be based on size and weight information as provided by the vendor, as well as the locations of the respective members and standard shipP1ng cost information as supplied by one or more package delivery companies. The host computer 20 may credits the acquiring member with additional VM credits corresponding to the estimated shipP1ng cost at a predetermined exchange rate, such as one VM credit per U.S. dollar equivalent.

In an alternative embodiment, VM 100 may be populated with articles consisting of articles designated as being available for trade or sale through the Sample Bag™ network, of the type described in applicant's co-pending PCT International patent application no. PCT/CA2013/050965. The contents of said application are incorporated herein by reference.

FIGS. 7A to 7C are representative screen shots showing selected steps of the present system and method as described above.

According to a further aspect, all users including vendors, bidding parties and barter parties may participate in a rating system whereby any user may rate the performance of any other user who has participated in an auction or barter exchange with the user. According to this aspect, at the conclusion of an auction or barter exchange, the host transmits a communication to all users, wherein the names of other users are identified therein. For example, if a given user is a vendor, he can be provided with the usernames of other bidders, which may comprise all other bidders or only the winning bidder. If the given user is a bidder, the communication may identify the vendor. The identified parties in the communication may be ranked, for example on scale of 1-5. The rankings may comprise overall rankings and/or categorized rankings appropriate to the class of ranked user. For example, if a vendor or barter exchange party is being ranked, the rankings may relate to categories such as promptness of shipP1ng, accuracy of description/photos, and other relevant ranking categories. Rankings of purchasers may relate to promptness of payment and other relevant factors.

In other aspects there is provided an apparatus comprising a computer readable storage medium storing instructions, which when executed in a processor of a computer, perform steps of the methods described herein. The computer readable storage medium may comprise a compact disc read-only memory (CD-ROM), USB flash drive, a hard disk, or other non-transitory computer storage device. It will be understood that the described embodiments may be implemented by a combination of hardware and software.

The scope of the present invention should not be limited by the preferred embodiments set forth in the examples but should be given the broadest interpretation consistent with the description as a whole. The claims are not to be limited to the preferred or exemplified embodiments of the invention.

1. A computer system for listing and displaying articles over a communications network, comprising:
a memory,
a communications interface configured to send and receive data over a communications network; and
a processor configured to:
generate a website to support the advertisement and exchange of articles;
receive a command to generate a new listing for an article associated with a user, the listing comprising keywords and information relating to the article;
determine that the new listing is similar to one or more previously generated listings stored in the memory; and
trigger a first bidding process for a first display priority for the new listing and one or more similar previously generated listings.

2. The system of claim i wherein once the bidding process is triggered, the processor is configured to receive bids associated with the similar listings, determine that a received bid is greater than a previously received bid, and display the listing associated with the received bid on the website based the first display priority.

3. The system of claim 2 wherein the processor is configured to terminate the bidding process after a predetermined time, identify the greatest bid at the end of the bidding process as the winning bid, determine the listing associated with the winning bid, and display the listing associated with the winning bid on the website based the first display priority.

4. The system of claim 3 wherein the processor is further configured to display remaining similar listings associated with non-winning bids on the website based on a random display priority.

5. The system of claim 3 wherein after determining that the received bid is greater than the previously received bid, the processor is further configured to deduct a real currency value corresponding to the received bid from an account of the user associated with the received bid.

6. The system of claim 5 wherein after terminating the bidding process, the processor is further configured to apply a virtual credit corresponding to each of the greatest bids, other than the winning bid, received during the bidding process to virtual credit accounts of associated users.

7. The system of claim 4 wherein the processor is further configured to notify the user associated with the new listing of the display of similar listings on the website.

8. The system of claim 1 wherein the memory comprises a database storing a plurality of listings for articles.

9. The system of claim 1 wherein the processor is configured to determine that the new listing is similar to previously generated listings stored in the memory by comparing keywords in the listings and identifying listings having a percentage match of keywords above a predetermined threshold.

10. The system of claim 1 wherein the listing comprises one of an offer to sell the article, an offer to barter for the article, an offer to trade the article, or a request for the article.

11. The system of claim 10 wherein the article comprises a good, a service, or a combination of a good and service.

12. The system of claim 1 wherein the processor is further configured to trigger a second bidding process for the acquisition of the article in the new listing.

13. The system of claim 1 wherein the first display priority comprises a preferred display position on the website.
